(19) United States
(12) Patent Application Publication
(10) Pub. No.: US 2003/0042691 A1
(43) Pub. Date: Mar. 6, 2003

(54) Packing material and gland packing used the material

(76) Inventors: Katsuro Tsukamoto, Takarazuka City (JP); Toshiharu Sakura, Osaka City (JP); Hiroaki Tsukamoto, Takarazuka City (JP)

Correspondence Address: Curtis L. Harrington & Associates, Suite 250, 6300 State University Drive, Long Beach, CA, 90815, US

(21) Appl. No.: 10/219,619

(22) Filed: Aug. 14, 2002

(30) Foreign Application Priority Data
Aug. 28, 2001 (JP) 2001-257689

(51) Int. Cl. F16J 15/02

(52) U.S. Cl. 277/633

(57) ABSTRACT

The present invention relates to the versatile packing material that has enough lubricating property, durability and sealing ability even if they are used under high PV value (speed of rotating shaft is more than 25 m/sec) to a shaft seal part of a fluid machinery where the rotating shaft rotates with high speed or under very high pressure to a seal of shuttle slide part of fluid machinery, and are high quality in durability, withstand pressure ability, heat resistance, lubricating property (low torque ability etc.), chemical resistance, sealing ability, low-emission ability and reducing production cost etc., further prevent electric corrosion to contact metal such as valve rod; packing material, wherein at least any one of carbonized fiber thread, carbon fiber thread, aramid resin fiber thread, phenol resin fiber thread, glass fiber thread, soogee, asbestos fiber thread and bundle of sprit carbon fiber is selected as base material, and in twisted periphery of the base material, a tape made of polytetrafluoro-ethylene is winded.

### BACKGROUND OF THE INVENTION

1. Field of the Invention

The present invention relates to packing material and gland packing used the material, more detail, the present invention relates to versatile packing material and gland packing used the material, which have enough lubricating property, durability and sealing ability even if they are used under high PV value (speed of rotating shaft is more than 25 m/sec) to a shaft seal part of a fluid machinery where the rotating shaft rotates with high speed or under very high pressure to a seal of shuttle slide part of fluid machinery, and are high quality in durability, withstand pressure ability, heat resistance, lubricating property (low torque ability etc.), chemical resistance, sealing ability, low-emission ability and reducing production cost etc., further prevent electric corrosion to contact metal such as valve rod.

2. Description of the Related Art

As a packing which seals a shaft of a fluid machinery, there are gland packing for rotating shaft used widely and gland packing for shuttle part of the fluid machinery (piston, plunger etc.) which are comprised asbestos, carbonized fiber, carbon fiber, PTFE (polytetrafluoro-ethylene) and aramid resin fiber.

These conventional gland packing has good and bad points in lubricating property, heat resistance and chemical resistance respectively. To compensate these defects, some packing which are comprised above-mentioned material are involved PTFE, but solid content of PTFE easily exfoliates from these packing which are involved PTFE in using, as a result, there are problems that stress relaxation occurs in early stage in using, hence life of packing becomes short, and not only wasteful but also operating torque of rotating shaft becomes high, therefore, abrasion of the rotating shaft becomes earlier, and leaking from sealing part increases.

These conventional packing can exercise relatively well in sealing ability or durability as seal member in betweenness in rest object, but as-mentioned above, they cannot have exercised enough durability, lubricating property and sealing ability as seal member which is used in relatively moving object under high PV value over speed of rotating shaft is more than 25 m/sec, especially in descaling pump, or seal member for plunger of reciprocating pump.

Further, asbestos used in conventionally is highly desirable in performance, but it causes environmental pollution issue such as pneumoconiosis etc., therefore, it will be wholly prohibited of using.

What is needed is versatile seal member which has high quality in durability, pressure resistance, heat resistance, lubricating property (low torque ability etc.), further prevent electric corrosion to contact metal such as valve rod etc.

### BRIEF SUMMARY OF THE INVENTION

The present invention is invented in consideration of these cases, its purpose is to provide versatile packing material and gland packing used the material which have enough lubricating property, durability and sealing ability even if they are used under high PV value (speed of rotating shaft is more than 25 m/sec) to a shaft seal part of a fluid machinery where the rotating shaft rotates with high speed, or under very high pressure to a seal of shuttle slide part of fluid machinery, and are high quality in durability, withstand pressure ability, heat resistance, lubricating property (low torque ability etc.), chemical resistance, sealing ability, low-emission ability and reducing production cost etc., further prevent electric corrosion to contact metal such as valve rod etc.

The present invention described in claim 1 is packing material, wherein at least any one of carbonized fiber thread, carbon fiber thread, aramid resin fiber thread, phenol resin fiber thread, glass fiber thread, soogee, asbestos fiber thread and bundle of sprit carbon fiber is selected as base material, and in twisted periphery on the base material, a tape made of polytetrafluoro-ethylene is winded.

The present invention described in claim 2 is packing material described in claim 1, wherein aramid resin fiber thread, carbon fiber thread, cotton thread, polytetrafluoro-ethylene fiber thread, wire of aluminium, wire of aluminium alloy, copper wire and copper alloy wire is selected as reinforcing material, and said base material is twisted so that the base material bundles the reinforcing material.

The present invention described in claim 3 is packing material described in claim 1, wherein in twisted periphery of said base material, compounding thread is consisted by winding reinforcing material selected at least any one of aramid resin fiber thread, carbon fiber thread, cotton thread, polytetrafluoro-ethylene fiber thread, wire of aluminium, wire of aluminium alloy, copper wire and copper alloy wire, and a tape consisted from said polytetrafluoro-ethylene is winded in periphery of said compounding thread.

The present invention described in claim 4 is packing material described in claim 1, wherein said tape includes pigment to separate by color. The present invention described in claim 5 is packing material described in claim 1, wherein said tape includes Silicon oil.

The present invention described in claim 6 is gland packing, wherein packing material described in claim 1 is braided, and braided packing material is pressed.

The present invention described in claim 7 is Gland packing, wherein packing material described in claim 2 is braided, and braided packing material is pressed.

The present invention described in claim 8 is gland packing, wherein packing material described in claim 3 is braided, and braided packing material is pressed.

The present invention described in claim 9 is gland packing, wherein packing material described in claim 4 is braided, and braided packing material is pressed.

The present invention described in claim 10 is gland packing, wherein packing material described in claim 5 is braided, and braided packing material is pressed.

The present invention described in claim 11 is gland packing described in claim 6, wherein before or after said packing material is braided, the packing material is impregnated antifunction at least any one of Silicon oil, liquid paraffin, wax, dispersoid polytetrafluoro-ethylene or dispersoid graphite etc.

The present invention described in claim 12 is gland packing described in claim 7, wherein before or after said packing material is braided, the packing material is impregnated antifunction at least any one of Silicon oil, liquid paraffin, wax, dispersoid polytetrafluoro-ethylene or dispersoid graphite etc.

The present invention described in claim 13 is gland packing described in claim 8, wherein before or after said packing material is braided, the packing material is impregnated antifunction at least any one of Silicon oil, liquid paraffin, wax, dispersoid polytetrafluoro-ethylene or dispersoid graphite etc.

The present invention described in claim 14 is gland packing described in claim 9, wherein before or after said packing material is braided, the packing material is impregnated antifunction at least any one of Silicon oil, liquid paraffin, wax, dispersoid polytetrafluoro-ethylene or dispersoid graphite etc.

The present invention described in claim 15 is gland packing described in claim 10, wherein before or after said packing material is braided, the packing material is impregnated antifriction at least any one of Silicon oil, liquid paraffin, wax, dispersoid polytetrafluoro-ethylene or dispersoid graphite etc.

### BRIEF DESCRIPTION OF THE DRAWINGS

FIG. 1 is a view showing an example of packing material of first embodiment which relates to the present invention.

FIG. 2 is a view showing an example of packing material of first and second embodiments which relate to the present invention.

FIG. 3 is a view showing an example of packing material of first and second embodiments which relate to the present invention.

FIG. 4 is a view showing an example of state of braiding of packing material which relates to the present invention.

FIG. 5 is a view showing an example of state of braiding of packing material which relates to the present invention.

FIG. 6 is a view showing an example of state of braiding of packing material which relates to the present invention.

FIG. 7 is a view showing an example of state of braiding of packing material which relates to the present invention.

FIG. 8 is a view showing a test embodiment of the gland packing which relates to the present invention, and it is a section view showing a state of the gland packing is loaded in a stuffing box of a fluid machinary.

FIG. 9 is a graph showing a test embodiment of the gland packing which relates to the present invention, and showing variation per hour of amount of leaking of liquid.

FIG. 10 is a graph showing a test embodiment of the gland packing which relates to the present invention, and showing variation per hour of temperature of the stuffing box.

FIG. 11 is a graph showing a test embodiment of the gland packing which relates to the present invention, and showing variation per hour of rotating torque of the rotating shaft.

FIG. 12 is a graph showing a test embodiment of the gland packing which relates to the present invention, and showing variation per hour of loaded length (mm) of the packing.

### DESCRIPTION OF PREFERED EMBODIMENTS OF THE INVENTION

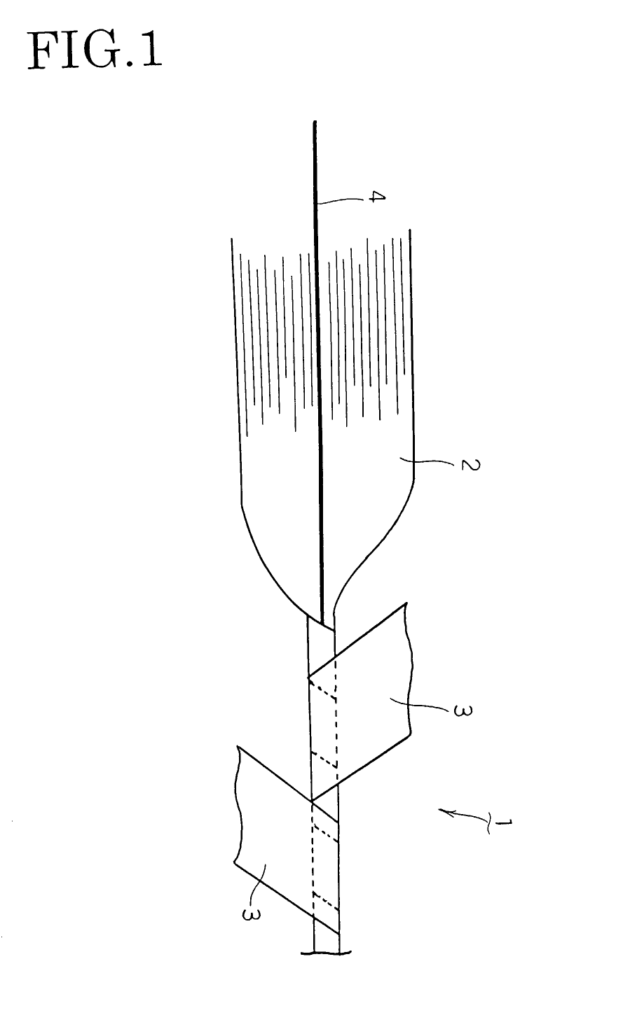

Hereinafter, preferred embodiments of the present invention are explained with referring to the drawings. FIG. 1 is a view showing an example of packing material of a first embodiment which relates to the present invention.

A packing material (1) which relates to the present invention is applied that a bundle of strip carbon fiber (referred as a bundle of sprit fiber hereinafter) as base material (2), and a tape (3) made of polytetrafluoro-ethylene (referred as PTFE hereinafter) is winded in twisted periphery of the base material (2).

The bundle of sprit fiber surpasses in mechanical strength, and hardly changes its property such as strength between −200 centigrade to +600 centigrade, so it surpasses in low temperature characteristics and in high temperature characteristics. Therefore, the bundle of sprit fiber can surely work as heartwood and solid antifriction in not only at normal temperatures but also under harsh environment. Further, the bundle of sprit fiber has outstanding lubricating and sealing ability, a packing which has outstanding lubricating and sealing ability can be gained. Moreover, since the bundle of sprit fiber surpasses in corrosion resistance and abrasion resistance, it can withstand long term usage even under a harsh environment such as a chemical plant.

Preferred width of the bundle of strip carbon fiber is 8 to 25 mm. The reason is that when the width is under 8 mm, enough lubricating and sealing ability cannot be gained, on the contrary, when the width is more than 25 mm, a big difference of thickness of a thread occurs when the thread is formed, and enough sealing ability cannot be gained, further, enough flexibility cannot be gained too.

A method for manufacturing of the bundle of sprit fiber is not particularly restricted, and it can be adopted the conventionally public known various methods for manufacturing, but it is desirable to use the method for manufacturing described in U.S. Pat. No. 3,049,225 or U.S. Pat. No. 3,064,019. In case of using these methods for manufacturing the bundle of sprit fiber described in official gazettes of manufacturing, carbon fiber multifilament is sent from a thread supply part to a taking up part with doing feed control to cause constant overfeed situation, and ventilate the air flow to the said multifilament to cross direction, and make this multifilament bow shape to leeward direction, and make this multifilament sheet type of the bundle of sprit fiber by separating a filament to width direction that composes this multifilament. By this method for manufacturing, high quality bundle of strip carbon fiber which the each fiber is stretched straight without cutting and fuzz, but with ranging regularly, arranging parallel to each other and fixed density can be gained.

Diameter of twisted bundle of strip carbon fiber is not restricted particularly, but preferred diameter is 0.6 to 2 mm. In the case of the diameter over 2 mm, braiding becomes to be difficult and it exerts a bad influence to sealing ability. Further, in case of the diameter is under 0.6 mm, the twisted bundle of strip carbon fiber may be damaged in braiding.

The tape (3) comprised PTFE serves as solid antifriction. Since PTFE has outstanding lubricating and sealing ability, a packing (1) which has outstanding lubricating and sealing ability can be gained. Moreover, since the bundle of sprit fiber surpasses in corrosion resistance and abrasion resistance, it hardly abrades for long term, even it touches tightly with high-velocity shaft under high pressure.

Thickness of the tape (3) is not restricted particularly, but 0.01 to 0.3 mm is desirable and 0.13 mm is more desirable. In case of the thickness exceeds 0.3 mm, winding is difficult. In case of the thickness is under 0.01 mm, the tape may be damaged in using with frictional heat.

Width of the tape is not restricted particularly, but 10 to 25 mm is desirable and 15 mm is more desirable. In case of the width is over 25 mm winding is difficult. Further, in case of the width is under 10 mm, ability of the tape is difficult to be performed, and the tape may be damaged in using by frictional heat.

The tape (3) is winded one fold or two fold on periphery of twisted base material (2) (two fold winding is shown in FIG. 1). When the tape is winded two fold, it can be further improved lubricating ability and sealing ability. In the case of two fold winding, when each winding directions of tapes are sat inverse direction and cross mutually, lubricating ability and sealing ability can be further increased. Further, when the tape (3) is winded two fold and its winding direction is inverse, it can perform same sealing ability and durability to a rotating shaft which rotates left handed rotation or right handed rotation.

Further, the tape (3) is winded so that at least each edge is pilled up. From here onwards, the base material (2) does not bare.

Further, it is desirable that Silicon oil is included in the tape (3). The content is not restricted particularly, desirably; it is sat about 3% by weight as component in the tape (3). The tape (3) is comprised by drawing PTFE powder with metal rolling roll, and in the state of powder, by including Silicon oil, fit to other parts after forming and formability of the tape (3) can be improved.

Further, it is desirable that pigment for color coding is included in the tape (3). By changing pigment color by a kind of the packing material (1), it is easily distinguish a kind of the packing material (1) by color.

As mentioned above, the tape (3) is comprised by drawing the PTFE powder with metal rolling roll, it is also desirable that the PTFE powder is calcined and has closed cell. By going through calcined process, durability of high pressure is brought a marked improvement.

In the packing material (1) which relates to the first embodiment, as shown in FIG. 1, it is desirable that at least one of aramid resin fiber thread, carbon fiber thread, cotton thread, polytetrafluoro-ethylene fiber thread, wire of aluminium, wire of aluminium alloy, copper wire and copper alloy wire (for example Monel or brass) is selected as reinforcing material (4), and the base material (2) is twisted so that the base material (2) twists as bundling the reinforcing material (4).

By having the reinforcing material (4) in center of the base material (2), intensity of the packing material (1) can be improved. The number of thread or wire rods which to be the reinforcing material (4) is a single or plural. In case of using plural thread, to twist them is desirable in improvement of intensity.

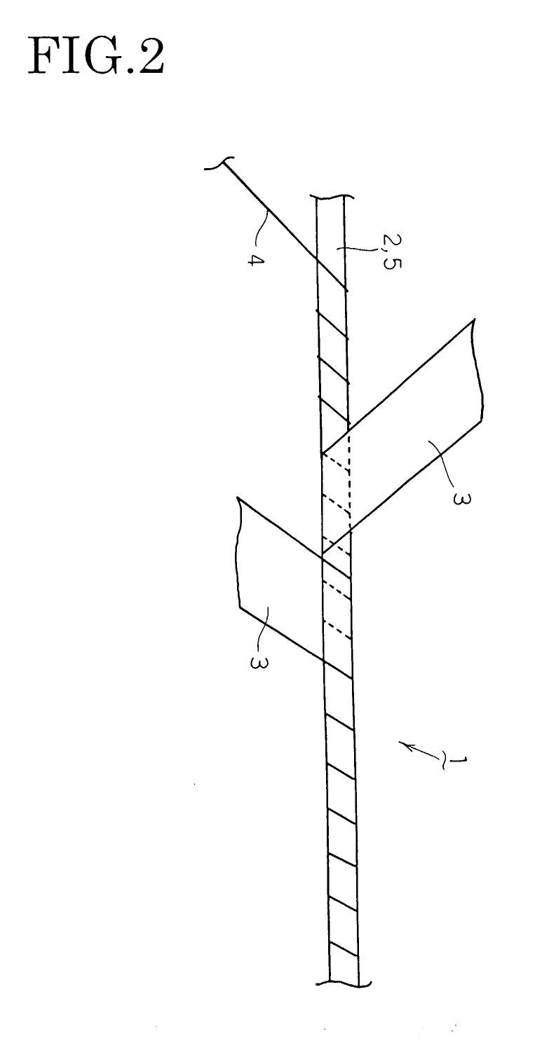

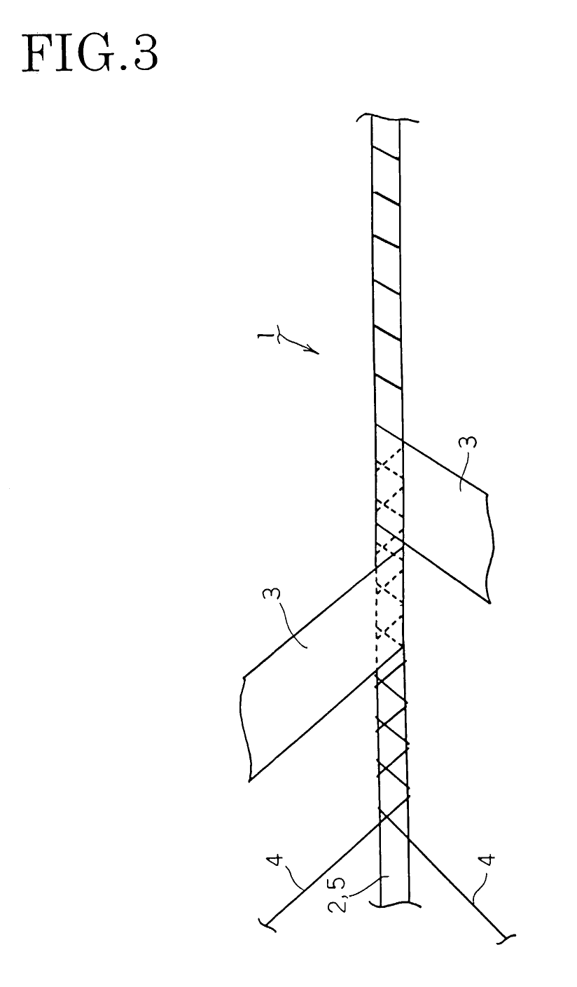

Further, in the first embodiment, as shown in FIG. 2 or 3, in twisted periphery of base material (2), compounding thread is comprised by winding reinforcing material (4) choose at least any one of aramid resin fiber thread, carbon fiber thread, cotton thread, polytetrafluoro-ethylene fiber thread, wire of aluminium, wire of aluminium alloy, copper wire and copper alloy wire, and the tape (3) consisted from said polytetrafluoro-ethylene is winded in periphery on said compounding thread.

By twisting the reinforcing material (4), it is possible to reduce a size of average diameter of the base material (2) by fasten the twisted base material (2) from outside. By this, in forming of packing, specific surface area of the packing material (1) in said packing can be enlarged, hence, sealing ability of the packing can be improved.

The reinforcing material (4) is twisted single fold (refer to FIG. 2) or double fold (refer to FIG. 3). In the case of two fold winding, if each winding directions of tapes are sat inverse direction and cross mutually, lubricating ability and sealing ability can further increase.

Further, it is desirable that the reinforcing material (4) twisted outside is very thin so that in twisting of the tape (3), the tape (3) coheres and does not come off from the base material (2). In the case of using plural thread as reinforcing material (4), to twist them is desirable in improvement of intensity.

The packing material (1) which relates to the first embodiment is fit well to a rotating shaft made of each metal, and pressure resistance, heat resistance and chemical resistance are superior, hence, it is possible to provide versatile packing material (1) and gland packing used the material, which have enough lubricating property, durability and sealing ability even if they are used under high PV value (speed of rotating shaft is more than 25 m/sec) to a shaft seal part of a fluid machinery where the rotating shaft rotates with high speed, and are high quality in durability, withstand pressure ability, heat resistance, lubricating property (low torque ability etc.), chemical resistance, sealing ability, low-emission ability and reducing production cost etc., further prevent electric corrosion to contact metal such as valve rod.

Next, packing material which relates to second embodiment is explained with reference to the FIGS. 2 and 3. The packing material (1) which relates to the second embodiment is at least any one of carbonized fiber thread, carbon fiber thread, aramid resin fiber thread, phenol resin fiber thread, glass fiber thread, soogee, asbestos fiber thread and bundle of sprit carbon fiber is selected as base material (5), and in twisted periphery of the base material (5), a tape (3) made of PTFE is winded.

The carbonized fiber is called as semi-carbon fiber since it is not carbonized perfectly, for example, man-made fiber such as acrylic etc. is calcined under temperature from 283 to 285 centigrade.

On the other hand, carbon fiber is fiber which is carbonized approximately perfectly, and there are PAN-based carbon fiber and pitch-based carbon fiber, and for example, the carbon fiber is made by man-made fiber such as acrylic or rayon calcined under temperature 600 to 1500 centigrade.

As aramid resin fiber, either meta-based or para-based is used. As meta-based, there is Normex (brand name). As hemp, either ramie or linen is used. In the second embodiment of the present invention, number of thread used as base material (5) is plural (usually two or three), and it is preferable that the thread is twisted for improving the strength.

The diameter of collected material (usually twisted material) is not limited particularly, but it is desirably 0.6 to 2 mm. In the case of the diameter is more than 2 mm, braiding is difficult. Further, if the diameter is under 0.6 mm, there is possibility of break in using.

As composition of the tape (3), it can be as same as the first embodiment of the present invention. In the second embodiment, the reinforcing material (4) can be arranged as same as the first embodiment.

In a packing material (1) which relates to the second embodiment, it can be versatile packing material (1) as same effect as the first embodiment, which has enough lubricating property, durability and sealing ability even if they are used under high PV value (speed of rotating shaft is more than 25 m/sec) to a shaft seal part of a fluid machinery where the rotating shaft rotates with high speed or under very high pressure to a seal of shuttle slide part of fluid machinery, and are high quality in durability, withstand pressure ability, heat resistance, lubricating property (low torque ability etc.), chemical resistance, sealing ability.

The gland packing which relates to the present invention can be gained by braiding the packing material (1) which relates to the first or second embodiment and by pressing the braided packing material.

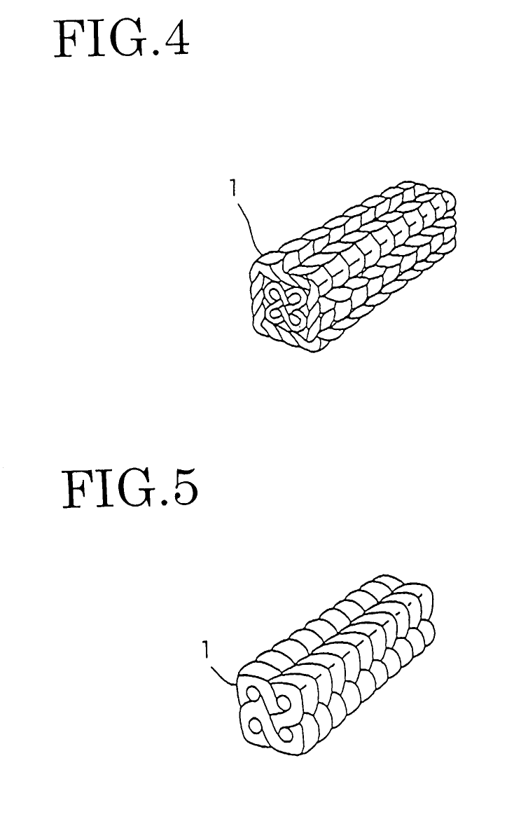

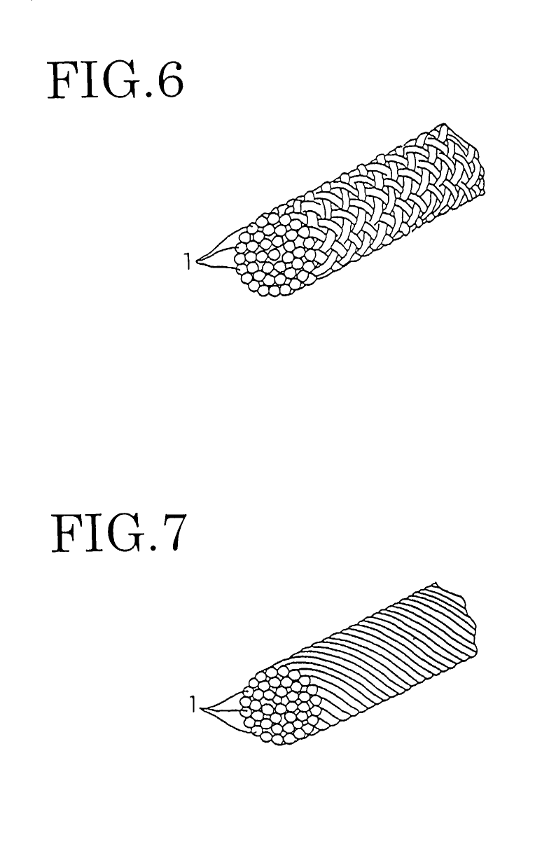

A form of braiding is not restricted particularly, for example, a cord body (refer to from FIGS. 4 to 7) in forms of knitted cord, braided cord, plaited cord and such can be constructed by braiding for example, one or plural packing material (1). In case of braiding cord, a spontaneous braiding method with four, eight, sixteen, eighteen, twenty-four or thirty-two of the braiding thread is possible.

Further, before or after braiding the packing material (1), it is preferable that at least one of antifriction such as silicon oil, liquid paraffin, wax, dispersoid polytetrafluoro-ethylene or dispersoid graphite is impregnated in the packing material (1), and gland packing is constructed by pressing the packing material (1) in ring-shaped.

Each of dispersoid polytetrafluoro-ethylene or dispersoid graphite is that fine polytetrafluoro-ethylene and graphite are dispersed in dispersing medium respectively.

By impregnating these antifrictions in the packing material (1), lubricating property of the gland packing can be further improved. As impregnating method, each of natural impregnating or vacuum impregnating can be selected.

Gland packing which relates to the present invention can be versatile gland packing that has enough lubricating property, durability and sealing ability even if they are used under high PV value (speed of rotating shaft is more than 25 m/sec) to a shaft seal part of a fluid machinery where the rotating shaft rotates with high speed or under very high pressure to a seal of shuttle slide part of fluid machinery, and are high quality in durability, withstand pressure ability, heat resistance, lubricating property (low torque ability etc.), chemical resistance, sealing ability, low-emission ability and reducing production cost etc., further prevent electric corrosion to contact metal such as valve rod.

Embodiment

Hereinafter, effect of the present invention is explained concretely by showing embodiment of the gland packing which relates to the present invention and measuring its capability. The present invention is not limited at all by the embodiment which is explained hereinafter.

Preparation of a Packing Material and a Gland Packing

A packing material which relates to the said first embodiment was prepared by a bundle of strip carbon fiber which was sat as a base material and by a tape made from PTFE was winded on exterior surface of the base material which was twisted.

The width of the base material was 25 mm, and a diameter of twisted base material was 2.0 mm. The thickness of the tape which was made from PTFE was 0.08 mm, and its width was 13 mm. The packing material was prepared by winding the tape one fold on periphery of the twisted base material.

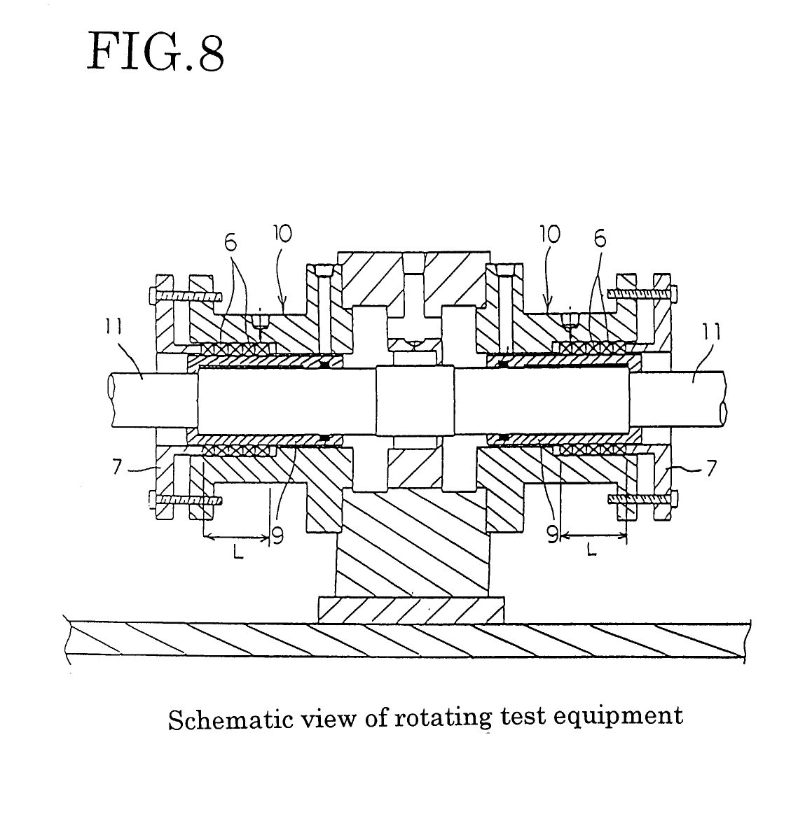

The packing material is braided, and a ring shaped gland packing (6) (refer to FIG. 8) is made by pressure forming of the braided packing material. The braiding is performed by interlocking braid.

1. Object

To identify sealing ability of the gland packing which relates to the present invention.

2. Test Formation

As shown in FIG. 8, a sleeve (9) is fixed integrally on exterior surface of a rotating shaft (11) which penetrates a stuffing box (10) of a fluid machinery. Five gland packing (5) are arranged in a low along axis direction of the rotating shaft (11) between exterior surface of the sleeve (9) and interior surface of the stuffing box (10).

On outside of the gland packing (6) which is positioned outside most, a push off device for a packing (7) is arranged.

Each packing (6) is squeezed to inside by the push off device for a packing (7). The rotating shaft (11) is drove with rotating by a motor (not shown).

3. Test Condition

Shaft diameter: φ85 (mm)

Diameter of a stuffing box: φ111 (mm)

Number of revolutions of the rotating shaft (11): 2404 rpm (10.7 m/sec)

Fluid in a fluid machinery: tap water

Pressure of fluid: 0.4 MPa

Test time: starting operation that rotates the rotating shaft (11) one hour and stops about 15 minutes is sat as one cycle, and the operation is performed more than 8 cycles.

4. Dimension of Test Portion (Gland Packing)

Internal diameter φ87×external diameter φ111×width 12×thickness 13 (unit:mm)

5. Measuring Item

1) Temperature of the stuffing box

2) Amount of fluid leakage

3) Sliding torque

4) Length of loaded packing (shown symbol (L) in Figures. The length is measured at accuracy until 0.01 mm)

6. Test procedure

1) Measure a sliding torque of the gland packing before loading the gland packing.

2) Load the gland packing in the stuffing box.

3) Measure length of loaded five arranged packing before tightening the gland packing.

4) Screw a volt for push off device for a packing with a tool, and tights the gland packing with this push off device.

5) Load fluid pressure 0.4 MPa.

6) When leaking of fluid is much, amount of leaking is adjusted by screwing more the volt.

7) Rotate a rotating shaft at 2404 rpm.

8) When leaking of fluid is much, amount of leaking is adjusted by screwing more the volt.

9) Each measurement of said measurement item is started.

10) After amount of leaking is stable, start-stop operation that rotates the rotating shaft one hour and stops about 15 minutes is sat as one cycle, and the operation is run more than 8 cycles.

11) Start-stop is run more than 8 cycles, and the test end.

7. Result

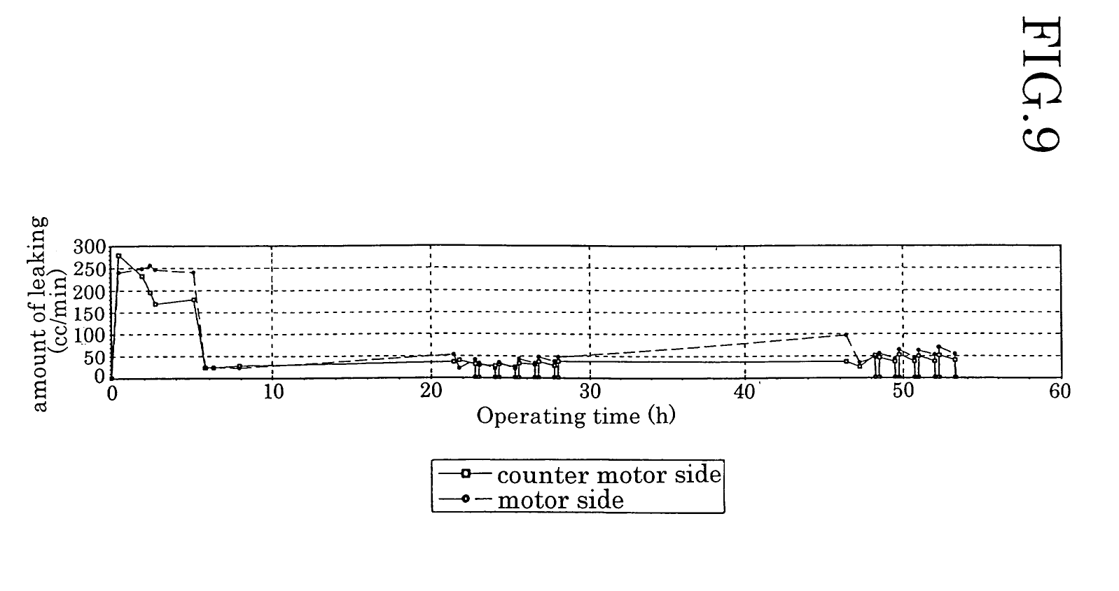

Test result is shown from FIG. 9 to FIG. 12.

FIG. 9 shows variation per hour of amount of leaking of liquid (cc/min).

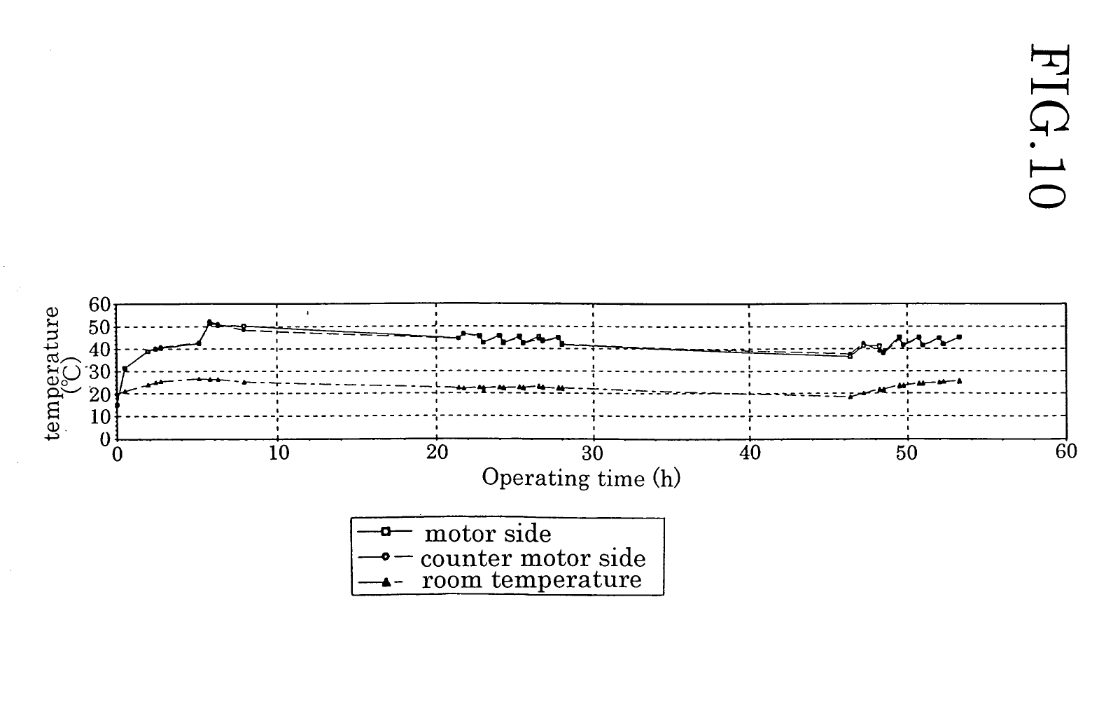

FIG. 10 shows variation per hour of temperature (° C.) of the stuffing box.

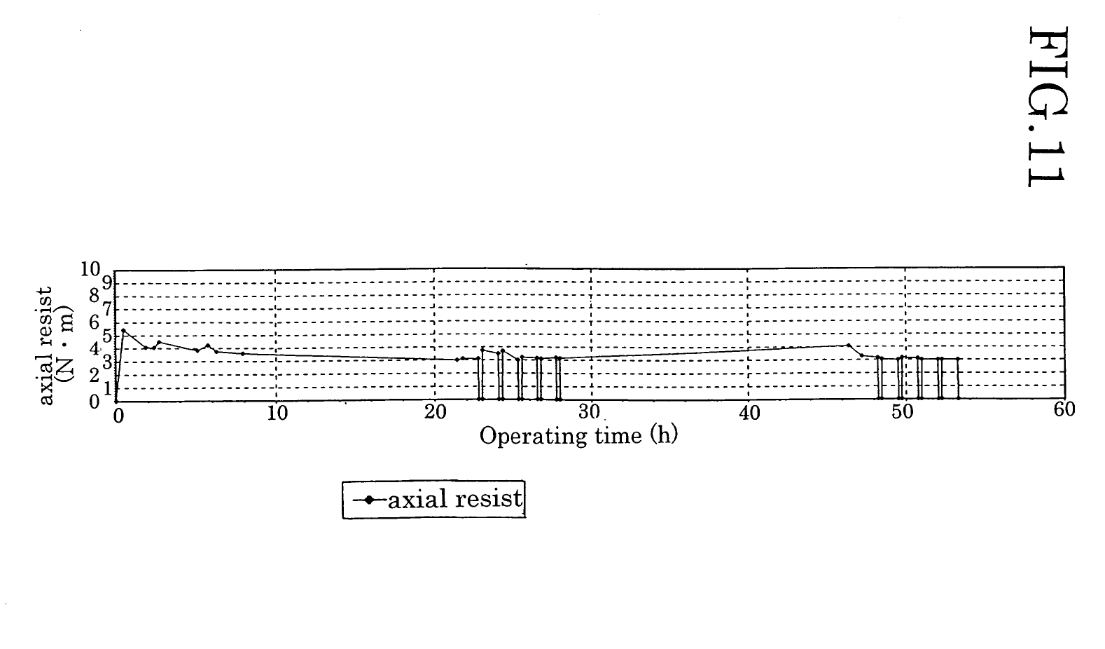

FIG. 11 shows variation per hour of rotating torque (N·m) of the rotating shaft.

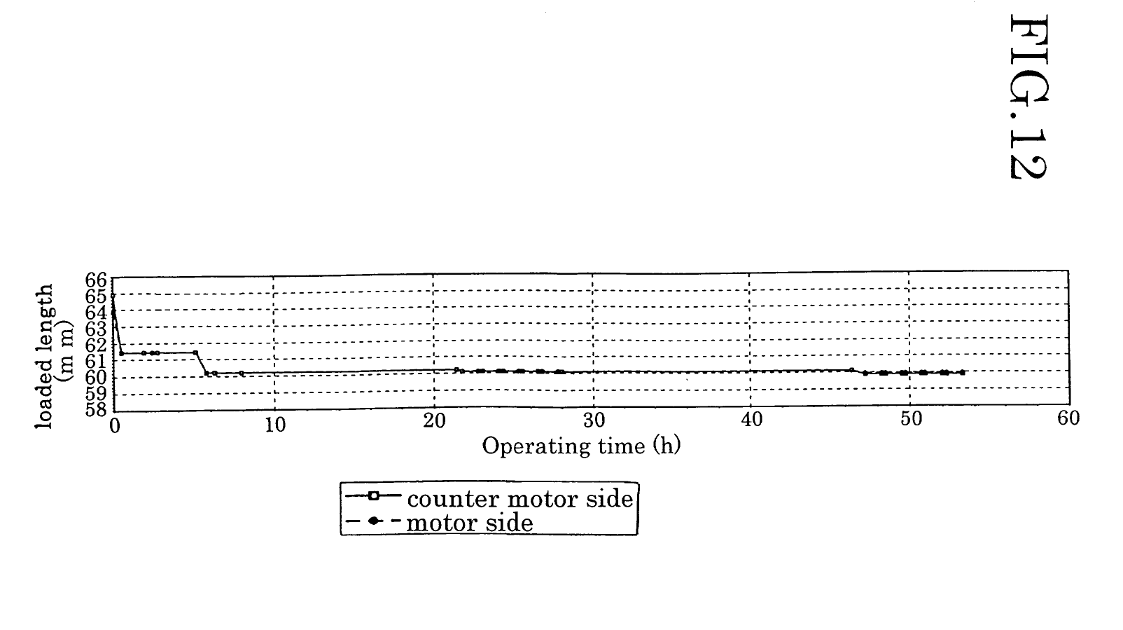

FIG. 12 shows variation per hour of loaded length (mm) of the packing.

8. Speculation

It is understandable from each graph that each of the amount of leaking of fluid, temperature of the stuffing box, rotating torque of the rotating shaft, and loaded length of the packing are in stable state after 10 hours. Once in a stable state, these values are almost same in rotating of the shaft, even if start-stop of rotating shaft is run repeatedly.

Therefore, the gland packing used in tests has enough lubricating property, durability and sealing ability with one gland packing (a kind), even if it is used under high PV value to a shaft seal part of a fluid machinery which the rotating shaft rotates with high speed.

Further, this gland packing can perform said superior capability, even if it is used under very high pressure to a seal of shuttle slide part of fluid machinery.

According to claim 1, since the packing material fit well with rotating shaft which comprises each metal, and it is well in heat resistance, high pressure resistance and chemical resistance, it can be packing material that has enough lubricating property, durability and sealing ability even if they are used under high PV value (speed of rotating shaft is more than 25 m/sec) to a shaft seal part of a fluid machinery where the rotating shaft rotates with high speed or under very high pressure to a seal of shuttle slide part of fluid machinery, and are high quality in durability, withstand pressure ability, heat resistance, lubricating property (low torque ability etc.), chemical resistance, sealing ability, low-emission ability and reducing production cost etc., further prevent electric corrosion to contact metal such as valve rod.

According to claim 2, the packing material can have higher durability and sealing ability.

According to claim 3, the packing material can have higher durability and sealing ability.

According to claim 4, by changing pigment color in each of the packing material, it is easy distinguish the kind of the packing material by color.

According to claim 5, fitting ability to other parts after forming and formability of the tape (3) can be increased.

According to from claim 6 to claim 10, the gland packing can be versatile gland packing that has enough lubricating property, durability and sealing ability even if they are used under high PV value (speed of rotating shaft is more than 25 m/sec) to a shaft seal part of a fluid machinery where the rotating shaft rotates with high speed or under very high pressure to a seal of shuttle slide part of fluid machinery, and are high quality in durability, withstand pressure ability, heat resistance, lubricating property (low torque ability etc.), chemical resistance, sealing ability, low-emission ability and reducing production cost etc., further prevent electric corrosion to contact metal such as valve rod.

According to from claim 11 to claim 15, the packing material can have higher lubricating property and sealing ability.

7. Result

Test result is shown from FIG. 9 to FIG. 12.

FIG. 9 shows variation per hour of amount of leaking of liquid (cc/min).

FIG. 10 shows variation per hour of temperature (° C.) of the stuffing box.

FIG. 11 shows variation per hour of rotating torque (N·m) of the rotating shaft.

FIG. 12 shows variation per hour of loaded length (mm) of the packing.

What is claims is:

1. Packing material, wherein at least any one of carbonized fiber thread, carbon fiber thread, aramid resin fiber thread, phenol resin fiber thread, glass fiber thread, soogee, asbestos fiber thread and bundle of sprit carbon fiber is selected as base material, and in twisted periphery on the base material, a tape made of polytetrafluoro-ethylene is winded.

2 Packing material described in claim 1, wherein aramid resin fiber thread, carbon fiber thread, cotton thread, polytetrafluoro-ethylene fiber thread, wire of aluminium, wire of aluminium alloy, copper wire and copper alloy wire is selected as reinforcing material, and said base material is twisted so that the base material bundles the reinforcing material.

3 Packing material described in claim 1, wherein in twisted periphery of said base material, compounding thread is consisted by winding reinforcing material selected at least any one of aramid resin fiber thread, carbon fiber thread, cotton thread, polytetrafluoro-ethylene fiber thread, wire of aluminium, wire of aluminium alloy, copper wire and copper alloy wire, and a tape consisted from said polytetrafluoro-ethylene is winded in periphery of said compounding thread.

4 Packing material described in claim 1, wherein said tape includes pigment to separate by color.

5 Packing material described in claim 1, wherein said tape includes Silicon oil.

6 Gland packing, wherein packing material described in claim 1 is braided, and braided packing material is pressed.

7 Gland packing, wherein packing material described in claim 2 is braided, and braided packing material is pressed.

8 Gland packing, wherein packing material described in claim 3 is braided, and braided packing material is pressed.

9 Gland packing, wherein packing material described in claim 4 is braided, and braided packing material is pressed.

10 Gland packing, wherein packing material described in claim 5 is braided, and braided packing material is pressed.

11 Gland packing described in claim 6, wherein before or after said packing material is braided, the packing material is impregnated antifriction at least any one of Silicon oil, liquid paraffin, wax, dispersoid polytetrafluoro-ethylene or dispersoid graphite etc.

12 Gland packing described in claim 7, wherein before or after said packing material is braided, the packing material is impregnated antifriction at least any one of Silicon oil, liquid paraffin, wax, dispersoid polytetrafluoro-ethylene or dispersoid graphite etc.

13 Gland packing described in claim 8, wherein before or after said packing material is braided, the packing material is impregnated antifriction at least any one of Silicon oil, liquid paraffin, wax, dispersoid polytetrafluoro-ethylene or dispersoid graphite etc.

14 Gland packing described in claim 9, wherein before or after said packing material is braided, the packing material is impregnated antifriction at least any one of Silicon oil, liquid paraffin, wax, dispersoid polytetrafluoro-ethylene or dispersoid graphite etc.

15 Gland packing described in claim 10, wherein before or after said packing material is braided, the packing material is impregnated antifriction at least any one of Silicon oil, liquid paraffin, wax, dispersoid polytetrafluoro-ethylene or dispersoid graphite etc.
